(19) United States
(12) Patent Application Publication
(10) Pub. No.: US 2026/0254383 A1
(43) Pub. Date: Aug. 27, 2026

(54) Method of Determining Torque in a Mechanical Drivetrain

(71) Applicant: Rockwell Automation Technologies, Inc., Mayfield Heights, OH (US)

(72) Inventors: Jonathan D Hoffman, Milwaukee, WI (US); Arun K. Guru, Brookfield, WI (US); Imthiaz Ahmed Aejaz Ahmed, Edina, MN (US); Aderiano M. daSilva, OakCreek, WI (US)

(21) Appl. No.: 19/065,060

(22) Filed: Feb. 27, 2025

(51) Int. Cl. H02P 21/20

(52) U.S. Cl. CPC H02P 21/20

(57) ABSTRACT

A motor drive utilizes an initial commissioning run to determine torque at a desired location along a drivetrain in real-time using an initial commissioning reference signal. Subsequent reference signals, corresponding to a desired operation of the motor after commissioning, are received at the motor drive. An output current from the motor drive is generated to control operation of the motor responsive to the subsequent reference signal. The output current from the motor drive is measured as it is supplied to the motor while executing the subsequent reference signal. An electromagnetic torque for the motor is determined using the motor drive as a function of the output current measured while executing the subsequent reference signal. The torque is determined at the location along the drivetrain while executing the subsequent reference signal as a function of the electromagnetic torque and of the torque determined at the location during the commissioning run.

### BACKGROUND INFORMATION

The subject matter disclosed herein relates to a motor controller configured to determine torque generated at one or more locations along a motor drivetrain. More specifically, the motor controller is configured to utilize training data to determine real-time torque values at one or more locations along the drivetrain without a physical sensor present.

As is known to those skilled in the art, motor drives are utilized to control operation of a motor. According to one common configuration, a motor drive includes a DC bus having a DC voltage of suitable magnitude from which an AC voltage may be generated and provided to an AC motor. The DC voltage may be provided as an input to the motor drive or, alternately, the motor drive may include a converter section which converts an AC voltage input to the DC voltage present on the DC bus. The converter section may be passive, including conventional diode rectification, or active, including controlled power electronic switching devices, either of which may convert an AC voltage input to a DC voltage for the DC bus.

The motor drive receives a command signal which indicates the desired operation of the motor. The command signal may be a desired torque, speed, or position at which the motor is to operate. The torque, speed, or position of the motor is controlled by varying the amplitude and frequency of the AC voltage applied to the stator of the motor. An inverter section is provided between the DC bus and the output of the motor drive to convert the DC voltage present on the DC bus to a controlled AC voltage at the output of the motor drive, where the controlled AC voltage is utilized to achieve desired operation of the motor.

As is also known to those skilled in the art, a motor shaft, extending from the motor, is coupled to a mechanical drivetrain to perform a desired action as a result of controlling operation of the motor. In some applications, such as a fan, the motor may be connected directly to the mechanical load. In other applications, additional elements, such as a gearbox, mechanical couplers or linkages, and additional drive shafts may be connected to the motor shaft to define a mechanical drivetrain. It is often desirable to know a value of torque present at one or more locations along the mechanical drivetrain. The torque value is useful in determining whether the components of the mechanical drivetrain are operating properly. For example, as components wear, additional torque may be required to continue operation of the mechanical drivetrain at a consistent speed. Failure of a component may be detected by a sudden spike in torque (e.g., a component in the drivetrain seized) or by a sudden drop in torque (e.g., a component in the drivetrain broke such that it no longer transfers torque). Still other failures, such as a product jam at an end effector or tool coupled to the mechanical drivetrain may be detected by changes in the torque present along the drivetrain.

However, detecting torque along the mechanical drivetrain is not without certain challenges. The torque present at different locations is dependent on multiple factors, such as gear ratio, mechanical efficiencies, and the like. The only torque value that may be directly determined by a motor drive is the electromagnetic torque generated at the output shaft of the motor. This electromagnetic torque is a function of the current present in the motor and of a torque constant for the motor. The motor drive includes current sensors at the output of the motor in order to regulate the current provided to the motor. The values of current measured by these current sensors may be used to determine electromagnetic torque generated by the motor. However, torque values at other locations along the drivetrain require torque sensors to be installed along the drivetrain. Torque sensors are typically expensive devices and require precise installation to achieve accurate measurements.

Thus, it would be desirable to provide an improved method and system for determining torque present at various locations along a mechanical drivetrain.

### BRIEF DESCRIPTION

According to one embodiment of the invention, a method for determining torque in a drivetrain in real-time includes receiving a reference signal at a motor drive, where the reference signal corresponds to a desired operation of a motor connected to the motor drive, and generating an output current from the motor drive to control operation of the motor. The output current from the motor drive is measured as it is supplied to the motor, and at least two coefficients, defining a torque constant of the motor, are obtained. An electromagnetic torque for the motor is determined using the motor drive. The electromagnetic torque is determined as a function of the output current and of the at least two coefficients defining the torque constant. A temperature of a winding in the motor is measured, and a compensated value of the electromagnetic torque generated by the motor is determined in real-time as a function of the electromagnetic torque and of the temperature of the winding. A rotor inertia and a motor friction of the motor are obtained, and a shaft torque for an output shaft of the motor in the motor drive is determined as a function of the electromagnetic torque, the rotor inertia, and the motor friction

According to another embodiment of the invention, a method for determining torque in a drivetrain in real-time includes receiving an initial commissioning reference signal at a motor drive and determining a torque at a location along the drivetrain other than an output shaft of a motor during the commissioning run. The commissioning reference signal corresponds to a desired commissioning run of the motor, connected to the motor drive, and of a portion of the drivetrain. A subsequent reference signal is received at the motor drive. The subsequent reference signal corresponds to a desired operation of the motor with the full drive train connected. An output current from the motor drive is generated to control operation of the motor responsive to the subsequent reference signal. The output current from the motor drive is measured as it is supplied to the motor while executing the subsequent reference signal. An electromagnetic torque for the motor is determined using the motor drive as a function of the output current measured while executing the subsequent reference signal. The torque is determined at the location along the drivetrain while executing the subsequent reference signal as a function of the electromagnetic torque and of the torque determined at the location during the commissioning run.

According to yet another embodiment of the invention, a system for determining torque at a point of interest along a drivetrain in real-time without a sensor mounted at the point of interest includes a motor operatively connected to drive the drivetrain and a motor drive operatively connected to control operation of the motor. The motor drive includes a current sensor operative to generate a current feedback signal corresponding to a current supplied from the motor drive to the motor and a processor. The processor is operative to execute at least one commissioning run of the motor. The at least one commissioning run controls operation of the motor according to a known motion profile. Either an operating parameter or at least one transfer function coefficient is stored in memory. The operating parameter or the at least one transfer function coefficient corresponds to a torque produced at the point of interest during the at least one commissioning run. At least one additional run is executed after the commissioning run, and an electromagnetic torque in the motor is determined as a function of the current supplied from the motor drive to the motor during the at least one additional run. A torque generated at the point of interest is determined in real-time during the at least one additional run as a function of the electromagnetic torque and the operating parameter or the at least one transfer function coefficient.

These and other advantages and features of the invention will become apparent to those skilled in the art from the detailed description and the accompanying drawings. It should be understood, however, that the detailed description and accompanying drawings, while indicating preferred embodiments of the present invention, are given by way of illustration and not of limitation. Many changes and modifications may be made within the scope of the present invention without departing from the spirit thereof, and the invention includes all such modifications.

### BRIEF DESCRIPTION OF THE DRAWINGS

Various exemplary embodiments of the subject matter disclosed herein are illustrated in the accompanying drawings in which like reference numerals represent like parts throughout, and in which:

FIG. 1 is a block diagram of a motor drive incorporating one embodiment of the present invention;

FIG. 2 is a block diagram representation of a rectifier section from the motor drive of FIG. 1;

FIG. 3 is a block diagram representation of an inverter section and gate driver module from the motor drive of FIG. 1;

FIG. 4 is a perspective view of an exemplary mechanical drivetrain along which torque values are determined;

FIG. 5 is a block diagram representation of communication between a motor drive and elements of a drivetrain;

FIG. 6 is a block diagram representation of one embodiment of a controller from the motor drive of FIG. 1;

FIG. 7 is a graphical representation of the relationship between current and torque in a motor;

FIG. 8 is a block diagram representation of the exemplary drivetrain of FIG. 4 with a torque transducer inserted;

FIG. 9 is a block diagram representation of a portion of the exemplary drivetrain of FIG. 4 with the load decoupled; and

FIG. 10 is a block diagram representation of the exemplary drivetrain of FIG. 4 with a position encoder mounted on the load.

In describing the various embodiments of the invention which are illustrated in the drawings, specific terminology will be resorted to for the sake of clarity. However, it is not intended that the invention be limited to the specific terms so selected and it is understood that each specific term includes all technical equivalents which operate in a similar manner to accomplish a similar purpose. For example, the word “connected,” “attached,” or terms similar thereto are often used. They are not limited to direct connection but include connection through other elements where such connection is recognized as being equivalent by those skilled in the art.

### DETAILED DESCRIPTION

The various features and advantageous details of the subject matter disclosed herein are explained more fully with reference to the non-limiting embodiments described in detail in the following description.

The subject matter disclosed herein describes an improved method and system for determining output torque at various locations along a mechanical drivetrain. As indicated above, a motor drive can only directly measure electromagnetic torque generated in the motor. The electromagnetic torque is a function of the current supplied from the motor drive to the motor to control operation of the motor. The present invention provides for a method of determining torque at other locations along a drivetrain coupled to the motor. A training, or commissioning, step is performed during which the motor drive obtains additional information about a particular location along the drivetrain. This additional information is used during subsequent operation of the motor to determine torque at the location during operation of the motor without requiring a torque sensor at that location.

According to one aspect of the invention, the motor drive receives characterization data of the motor. The characterization data may be provided in a motor data sheet, supplied by a manufacturer of the motor, and which accompanies the motor. The motor data sheet may, for example, define a non-linear relationship between measured output current and motor torque, including multiple non-linear relationships corresponding to varying operating temperatures of the motor. The motor data sheet may further include information corresponding to motor friction and/or rotor inertia. Values of these various characterization data may be stored in the motor drive and utilized to determine electromagnetic torque and the torque present on the output shaft of the motor.

According to another aspect of the invention, a torque transducer may be temporarily connected to a location of interest along the drivetrain. One or more commissioning runs may be performed, where the torque is measured by the torque transducer during these commissioning runs. The measured torque is compared to an estimated torque value generated by a model of the drivetrain present in the motor drive. Parameters within the model of the drivetrain are adjusted until the estimated torque corresponds to the measured torque. The torque transducer is removed for normal operation of the motor, and the estimated torque is then utilized during subsequent operation to determine torque present at the location of interest along the drivetrain.

According to yet another aspect of the invention, a portion of the drivetrain is connected to the motor, where the last point of the drivetrain connected is the location of interest. A series of commissioning runs are performed, during which the motor is operated both at a constant speed and at a constant acceleration. Performance of the motor is monitored during each commissioning run, and a transfer function of the torque between the motor shaft and the location of interest is determined. Alternately, a position sensor is connected to the location of interest. With a known load present at the location of interest, a transfer function of the torque between the motor shaft and the location of interest may be determined utilizing measured velocity and acceleration determined from the feedback of the position sensor. The transfer function may be utilized during subsequent operation to determine torque present at the location of interest along the drivetrain.

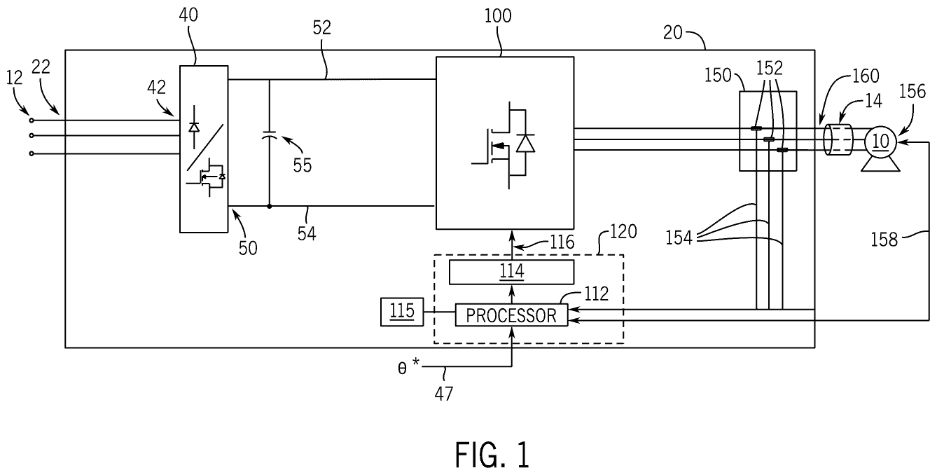

Turning initially to FIG. 1, a motor drive 20 for determining output torque at various locations along the mechanical drivetrain according to one embodiment of the present invention is illustrated. An AC voltage 12 is provided at an input 22 to the motor drive 20. According to the illustrated embodiment, the AC voltage 12 is a three-phase AC input voltage. The motor drive supplies an AC output voltage from an output 160 of the motor drive to a motor 10 operatively connected to the motor drive 20 via a cable 14. The output voltage is a three-phase AC output voltage with individual conductors shown extending between the motor 10 and drive 20 for each phase of the motor. It is understood that the illustrated conductors may be combined within a cable 14, run as individual conductors, or a combination thereof according to the application requirements.

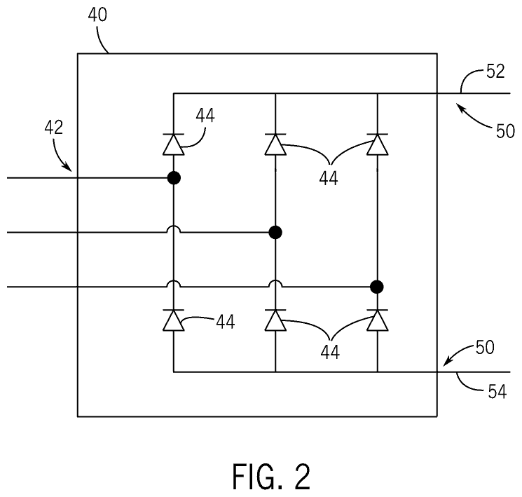

The AC input voltage 12 is provided to a converter section 40 of the motor drive 20. One or more additional filters may be included between the input 22 of the motor drive and the converter section 40 according to the application requirements. The converter section 40 may include any electronic device suitable for passive or active rectification as is understood in the art. With reference also to FIG. 2, the illustrated converter section 40 is a passive converter and includes a set of diodes 44 forming a diode bridge. The converter section 40 receives the AC voltage 12 at an input 42, rectifies the three-phase AC voltage to a DC voltage, and provides the DC voltage to a DC bus 50 at an output of the converter section. Optionally, the converter section may be an active converter, which includes gate-controlled switching devices including, but not limited to, thyristors, silicon-controlled rectifiers (SCRs), or silicon based transistors, such as insulated gate bipolar transistors (IGBTs) or metal oxide semiconductor field-effect transistors (MOSFETs). The converter section may alternately include high frequency switching devices including, but not limited to, Silicon Carbide (SiC) or Gallium Nitride (GaN) wide band gap IGBTs or MOSFETs which may switch in the twenty kilohertz (20 kHz) to the megahertz range to convert the voltage at the input 42 from AC to a DC voltage for the DC bus 50. The DC bus 50 is connected to the output of the converter section 40, and the DC voltage output by the converter is present between the positive rail 52 and the negative rail 54 of the DC bus 50.

Referring again to FIG. 1, a DC bus capacitor 55 is connected between the positive and negative rails, 52 and 54, to reduce the magnitude of the ripple voltage resulting from converting the AC voltage to a DC voltage. It is understood that the DC bus capacitor 55 may be a single capacitor or multiple capacitors connected in parallel, in series, or a combination thereof. The magnitude of the DC voltage between the negative and positive rails, 54 and 52, is generally equal to the magnitude of the peak of the AC input voltage. The DC bus 50 is connected in series between the converter section 40 and an inverter section 100. One or more additional filters may be included between the converter section 40 and the inverter section 100 according to the application requirements.

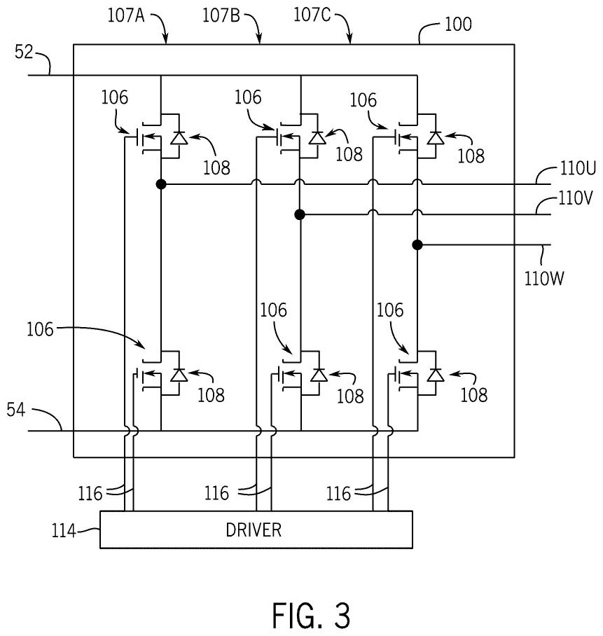

The inverter section 100 consists of gate-controlled switching elements as described for the active converter 40, such as silicon and/or wide band gap materials for IGBTs or MOSFETs, or Silicon Gate Controlled Thyristors (SCGT) and Gate Turn-Off thyristors (GTO) for medium voltage, high power units gap transistors as is known in the art. With reference also to FIG. 3, the illustrated inverter section 100 includes a power metal-oxide-semiconductor field-effect transistor (MOSFET) 106 and a reverse connected device 108, which may be a free-wheeling diode or a MOSFET's inherent body diode, connected in pairs between the positive rail 52 and each phase of the output voltage (110 U, 110V, 110 W) as well as between the negative rail 54 and each phase of the output voltage. Each of the transistors 106 receives switching signals 116 to selectively enable the transistors 106 and to convert the DC voltage from the DC bus into a controlled three phase output voltage to the motor 10. When enabled, each transistor 106 connects the respective rail 102, 104 of the DC bus to one output phase 110, which is, in turn, connected between the inverter section 100 and the output terminal 160. One or more additional filters may be included between the output of the inverter section 100 and the output terminals 160 of the motor drive 20 according to the application requirements.

A current sense module 150 is provided at the output of the motor drive. The current sense module 150 includes a current sensor 152 on each phase of the AC output voltage. Each current sensor 152 generates a current feedback signal 154 corresponding to the current present at the output 160 of the motor drive for each phase of the AC output.

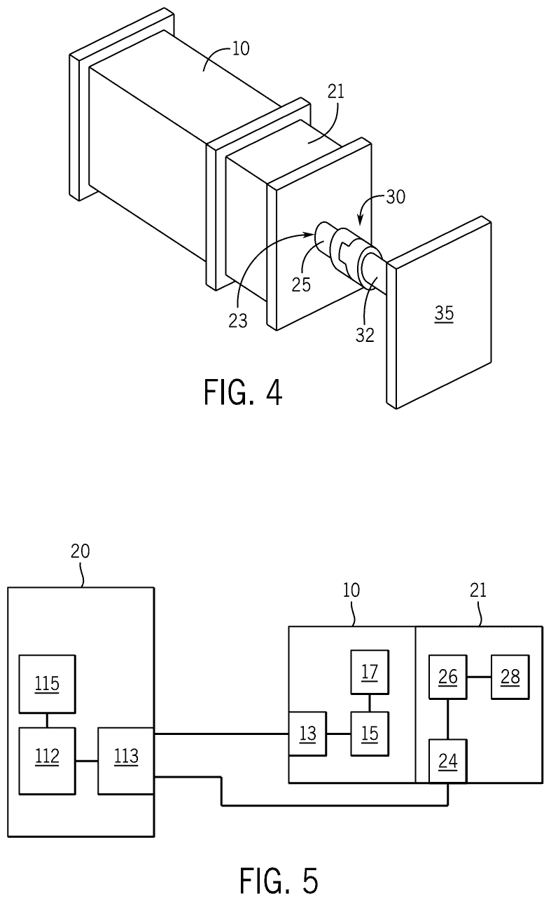

Turning next to FIG. 4, an exemplary drivetrain is illustrated for which values of torque may be determined at different locations along the drivetrain. A motor 10 is controlled by a motor drive, as discussed above. An output shaft from the motor 10 is coupled to a gearbox 21. The gearbox 21, in turn, includes an output shaft 25 which is supported by bearings 23. The gearbox is configured to convert a speed of rotation between the output shaft of the motor 10 and the output shaft 25 of the gearbox 21 according to a gear ratio present within the gearbox. Commonly, the angular velocity of the output shaft 25 of the gearbox 21 is reduced in comparison to the output shaft of the motor 10. As is understood in the art, a reduction in speed through the gearbox 21 results in an increase in torque present on the output shaft 25 of the gearbox. Thus, the torque present at the output of the gearbox differs from the torque present at the output of the motor 10. A coupler 30 is also illustrated in FIG. 4. The coupler 30 is a two-part coupler with a first portion mounted to the output shaft 25 of the gearbox 21 and a second portion mounted to a drive shaft 32 for a load 35. The coupler 30 may serve multiple functions. The coupler facilitates interconnection of two shafts 25, 32. Further, the coupler 30 may serve as a point of failure if, for example, the load 35 becomes jammed. Failure in the coupler 30 may prevent damage to the gearbox 21 and/or motor 10 driving the load 35. The load 35 is illustrated as a single box for convenience of illustration. However, the load 35 may include additional stages with further gearboxes, linkages, tools, wheels, end effector, or other actuator driven by the motor. At each stage along the drivetrain between the motor 10 and the final point at which work is performed on the load 35, the torque will vary due to gear ratios, mechanical inefficiencies, and the like.

In operation, the motor drive 20 is configured to control operation of the motor 10, connected at the output 160 of the motor drive, and, in turn, control operation of the load 35 connected to the motor. With reference again to FIG. 1, a processor 112 and a driver circuit 114 may include and manage execution of modules used to control operation of the motor drive 20. The driver circuit 114 may be a dedicated modulation circuit, a separate core executing on the processor 112, or a module executing on the processor 112. For convenience, the driver circuit 114 and the processor 112 may be referred to herein as a controller 120 for the motor drive 20. The illustrated embodiment is not intended to be limiting and it is understood that various features of each module may be executed by another module and/or various combinations of other modules may be included in the processor 112 or driver circuit 114 without deviating from the scope of the invention. The modules may be stored programs executed on one or more processors, logic circuits, or a combination thereof. The processor 112 may be implemented, for example, in a microprocessor, application specific integrated circuit (ASIC), field programmable gate array (FPGA), or other such customizable device. The motor drive 20 also includes a memory device 115 in communication with the processor 112. The memory device 115 may include transitory memory, non-transitory memory or a combination thereof. The memory device 115 may be configured to store data and programs, which include a series of instructions executable by the processor 112. It is contemplated that the memory device 115 may be a single device, multiple devices, or incorporated, for example, as a portion of another device such as an application specific integrated circuit (ASIC). The processor 112 is in communication with the memory 115 to read the instructions and data as required to control operation of the motor drive 20.

According to one embodiment of the invention, the processor 112 receives a reference signal identifying desired operation of the motor 10 connected to the motor drive 20. The reference signal may be, for example, a torque reference (T*), a speed reference (ω*), or a position reference (θ*). The processor 112 also receives feedback signals indicating the current operation of the motor drive 20. The motor drive 20 may include a voltage sensor and/or a current sensor operatively connected to the DC bus 50 and generating a feedback signal corresponding to the magnitude of voltage and/or current present on the DC bus. The motor drive 20 may also include one or more current sensors 152 and one or more voltage sensors on each phase of the AC output voltage generating feedback signals 154 corresponding to the magnitude of output current and/or voltage present at the output 160 of the motor drive 20.

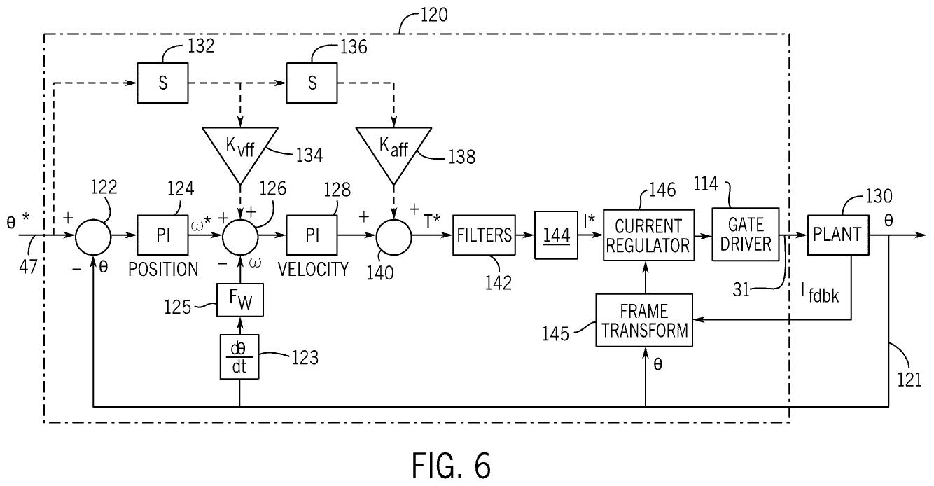

The processor 112 utilizes the feedback signals and the reference signal to control operation of the inverter section 100 to generate an output voltage having a desired magnitude and frequency for the motor 10. With reference also to FIG. 6, an exemplary controller 120 for the motor drive 20 is illustrated. The controller 120 may be implemented as a series of instructions stored in the memory 115 of the motor drive 20 and executed on the processor 112. The illustrated controller 120 receives a position reference signal (θ*) 47 as an input to a series of cascaded control loops. The controller 120 includes a position control loop, a velocity control loop and a current control loop. The control loops are shown as cascading control loops where an output of one control loop is provided as an input to another control loop. It is contemplated that various other control topologies may be utilized within the motor drive 20.

In the position control loop, the position reference signal (θ*) 47 is compared to a position feedback signal (θ) 121 at a first summing junction 122. A position error signal is output from the first summing junction 122 and input to a position loop controller 124. According to the illustrated embodiment, the position loop controller 124 is a proportional-integral (PI) controller. Optionally, the position loop controller 124 may be just a proportional (P) controller or further include a derivative (D) component. Each of the proportional (P), integral (I), and/or derivative (D) components of the position loop controller 124 includes a controller gain. The position loop controller gains are commonly referred to as a position loop proportional gain (Kₚₚ), position loop integral gain (Kₚᵢ), and a position loop derivative gain (K_{pd}). The output of the position loop controller 124 is a velocity reference signal (ω*).

In the velocity control loop, the velocity reference signal (ω*) is compared to a velocity feedback signal (ω) at a second summing junction 126. The velocity feedback signal (ω) is generated by taking a derivative, as shown in the derivative block 123, of the position feedback signal (θ). The velocity feedback signal (ω) may also be filtered by a velocity filter block 125. A velocity error signal is output from the second summing junction 126 and input to a velocity loop controller 128. According to the illustrated embodiment, the velocity loop controller 128 is a proportional-integral (PI) controller. Optionally, the velocity loop controller 128 may be just a proportional (P) controller or further include a derivative (D) component. Each of the proportional (P), integral (I), and/or derivative (D) components of the velocity loop controller 128 includes a controller gain. The velocity loop controller gains are commonly referred to as a velocity loop proportional gain (Kᵥₚ), velocity loop integral gain (Kᵥᵢ), and a velocity loop derivative gain (K_{vd}). The output of the velocity loop controller 128 is an acceleration reference signal.

The controller 120 may also include feed forward branches. According to the illustrated embodiment, the controller 120 includes feed forward branches for both the velocity and the acceleration elements. The position reference signal (θ*) 47 is passed through a first derivative element 132 to obtain a velocity feed forward signal. The velocity feed forward signal is multiplied by a velocity feed forward gain (K_{vff}) 134 and combined with the velocity reference signal (ω*) and the velocity feedback signal (ω) at the second summing junction 126. The velocity feed forward signal is passed through a second derivative element 136 to obtain an acceleration feed forward signal. The acceleration feed forward signal is multiplied by an acceleration feed forward gain (K_{aff}) 138 and combined with the acceleration reference signal at a third summing junction 140 to generate a torque reference signal (T*). As is known in the art, the torque required by a motor to achieve a desired acceleration is related according to the inertia of the motor. A gain block including the inertia of the motor may be included between the outputs of both the velocity loop controller 128 and the output of the acceleration feed forward gain and the third summing junction 140 to convert the acceleration signals to torque signals. Optionally, the inertia of the motor may be incorporated into the gains of the velocity loop controller 128 and the acceleration feed forward gain such that the output of the velocity loop controller 128 and the acceleration feed forward block are both torque signals. According to still another option, the third summing junction 140 may combine acceleration signals and an inertial gain block may be included after the third summing junction 140 to generate the torque reference signal (T*).

The torque reference signal (T*) output from the third summing junction 140 is further processed prior to generating gate signals 116 for the inverter section 100. The torque reference signal (T*) is provided as an input to a filter section 142, which may include one or more filters to remove unwanted components from the control system, such as a low pass filter to attenuate undesirable high frequency components or a notch filter to attenuate specific frequency components having an undesirable effect on the controlled mechanical load. The output of the filter section 142 is passed through a torque gain block 144. The torque gain block 144 may include a torque constant (Kₜ) which defines a relationship between the current provided to the motor 10 and the torque output by the motor. The torque gain block 144 may include one or more additional gain elements, such as inertia-related gains, combined with the torque constant (Kₜ) to produce a desired current reference (I*) to a current regulator 146. The current regulator 146 receives a current feedback signal (I_{fdbk}) from the current sensors 152 at the output of the motor drive 20 and utilizes a current controller, which may include proportional, integral, and/or derivative components to regulate the current in the motor 10.

The current feedback signal (I_{fdbk}) is received at the controller 120 as signals corresponding to individual phases of the motor. The current feedback signal (I_{fdbk}), as illustrated, includes multiple feedback signals, where each signal corresponds to an amplitude of current as measured on one phase of the multi-phase motor 10. For a three-phase motor, it is contemplated that the amplitude of current is measured in all three phases of the motor. Optionally, the amplitude of current is measured in two phases of the motor and the amplitude of the third phase is determined as a function of the amplitude of the two measured phases. The current sense module 150 generates current feedback signals, and the measured feedback signals are then provided to a reference frame transformer 145 within the controller 120 for use by the current regulator 146.

The reference frame transformer 145 is configured to transform the current feedback signals from the stationary, physical reference frame in which the signals are measured to a rotating reference frame. The reference frame transformer 145 receives the measured phase currents in a stationary reference frame (I_{fdbk}) and a position feedback signal (θ) as inputs. The position feedback signal (θ) corresponds to an angular position of the motor 10. The position feedback signal (θ) may be a mechanical angular position of the motor or an electrical angular position corresponding to the electrical angle of the current provided to the motor 10. The transform between reference frames, however, utilizes electrical angular position of the current to convert the current feedback signal from the stationary reference frame to a rotating reference frame. Therefore, if the position feedback signal (θ) is the mechanical angular position of the motor, the reference frame transformer 145 first converts the mechanical angular position of the motor to the electrical angle of the current as a function of the number of poles in the motor. In the stationary reference frame, the current applied to the motor 10 varies sinusoidally at a commanded frequency output by the motor controller 20. If the current feedback signals are converted to a reference frame that rotates at an identical frequency to the commanded frequency, the rotating reference frame is synchronous to the output current and the current feedback signal becomes a “DC”, or constant, value.

The reference frame transformer 145 is used to convert the measured current feedback signals to a synchronous reference frame rotating at the fundamental frequency of the current output to the motor 10. As shown below in Eqs. 1 and 2, the frame transformation utilizes the electrical angle of the motor and the amplitude of the currents measured in the motor to generate a synchronous current feedback signal rotating at the fundamental frequency of the motor. Equation 1 defines the current in the “d” axis, and equation 2 defines the current in the “q” axis. Both currents are present when the feedback current is referred to in the d-q axes. The synchronous current feedback signal output from the reference frame transformer 145 is in the synchronous reference frame, also referred to as a d-q reference frame, and includes both the d axis and the q axis components of current. The synchronous current feedback signal is provided as an input to the current regulator 146 in order to generate a voltage reference signal, where the voltage reference signal, when applied to the motor 10, generates the desired current reference, I*, input to the current regulator 146.

$${i}_{d\_fund} = \frac{2}{3} [ {i}_{a} cos θ + {i}_{b} cos ( θ - 120 ° ) + {i}_{c} cos ( θ - 240 ° ) ] \qquad ( 1 )$$

$${i}_{q\_fund} = - \frac{2}{3} [ {i}_{a} sin θ + {i}_{b} sin ( θ - 120 ° ) + {i}_{c} sin ( θ - 240 ° ) ] \qquad ( 2 )$$

$$where :$$

$$\begin{matrix}θ = electrical angle ; \\ {i}_{a} = amplitude of current in phase “ a ” of the motor ; \\ {i}_{b} = amplitude of current in phase “ b ” of the motor ; and \\ {i}_{b} = amplitude of current in phase “ c ” of the motor .\end{matrix}$$

The output of the current regulator 146 is a voltage reference in the d-q reference frame. The voltage reference may be converted to a stationary reference frame or represented as a magnitude and phase angle. The electrical angle is used to convert the voltage reference back to reference voltages for each phase voltage. The voltage reference is provided to the gate driver 114 which, in turn, generates the switching signals 116 to the inverter section 100. It is contemplated that the voltage reference may be transformed back to phase voltages prior to being provided to the gate driver 114. Optionally, the gate driver 114 may be configured to perform the inverse transform and then generate the switching signals. The output of the gate driver 114 is illustrated as being supplied to the plant 130 of the controlled system. In a motion control system, the plant 130 typically includes the inverter section 100 of the motor drive 20, the motor 10, a mechanical load, a position feedback device, and mechanical couplings between the motor and mechanical load or between the motor and a position feedback device. The position feedback device generates the position feedback signal (θ) used by the controller 120.

The gate driver module 114 converts the voltage reference output from the current regulator to a desired output voltage having a variable amplitude and frequency, where the amplitude and frequency are selected to produce the desired operation of the motor 10. The gate driver module 114 then generates the switching signals 116 used by pulse width modulation (PWM) or by other modulation techniques to control the switching elements in the inverter section 100 to produce the desired output voltage. The switching signals 116 subsequently enable/disable the transistors 106 to provide the desired output voltage to the motor 10, which, in turn, results in the desired operation of the mechanical load coupled to the motor 10.

As is understood in the art, transforming measured current from the physical reference frame to the synchronous reference frame is useful for determining torque generated by a motor. The current in the q-axis is torque producing current, and current in the d-axis is flux producing current. A common method of determining torque generated by a motor 10 is by multiplying the current in the q-axis by a torque constant for the motor. In many applications, the value of the electromagnetic torque determined by multiplying the q-axis current with the torque constant provides a sufficient level of accuracy. However, in other applications, it may be desirable to obtain a more precise determination of electromagnetic torque.

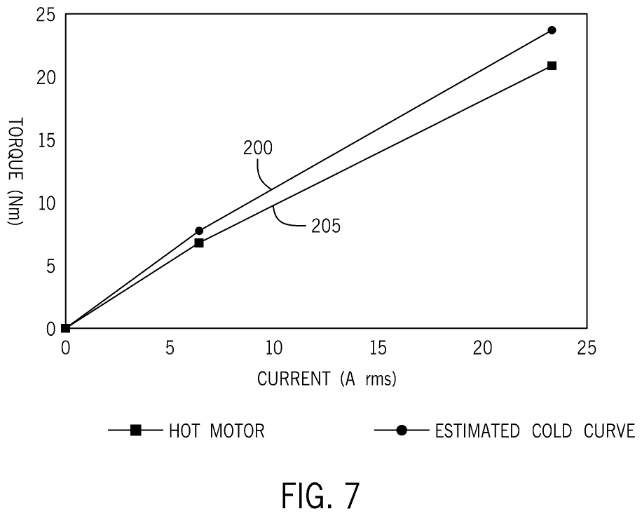

The present invention utilizes a non-linear representation of the torque constant to determine electromagnetic torque in the motor 10. With reference to FIG. 7, a first plot 200 describes a relationship between the current output by the motor drive 20 and the electromagnetic torque generated by the motor 10 at ambient temperature. FIG. 7 also includes a second plot 205 describing the relationship between the current output by the motor drive 20 and the electromagnetic torque generated by the motor 10 when the motor temperature increases. As illustrated in FIG. 7, the plots indicate that the relationship between current and torque is non-linear and that the relationship varies as a function of temperature. The relationship between current and torque may be provided in a motor datasheet. Optionally, the motor 10 may be operated at ambient temperature and with different known loads to determine the current associated with each load. The motor 10 may then be run to reach a desired temperature and again be operated at the desired temperature with different known loads to determine the current associated with each load. Having obtained the relationships between current and torque for both ambient temperature and an increased temperature, the electromagnetic torque may be determined utilizing a function which is curve fit to the non-linear relationship between current and torque. According to one embodiment of the invention, a second order function includes a first coefficient which is multiplied by a square of the q-axis current. A second coefficient is multiplied by an absolute value of the q-axis current. The two products are then added together, and a polarity of the sum is determined according to the sign of the q-axis current. The resultant value is the electromagnetic torque in the motor. It is contemplated that other second order equations may be used and, similarly, other equations of different orders with additional coefficients may be used.

The electromagnetic torque in the motor may additionally be compensated according to a measured temperature in the motor. A compensation torque constant is determined as a function of the measured temperature, and a ratio of the compensation torque constant to a torque constant at rated temperature is used to adjust the electromagnetic torque as a function of the measured temperature. The compensation torque constant may be determined by equation 3 below.

$${K}_{{t}_{comp}} = {K}_{{t}_{hot}} - ( \frac{{K}_{{t}_{hot}} - {K}_{{t}_{cold}}}{{T}_{rated} - {T}_{ambient}} ) ( {T}_{rated} - {T}_{winding} ) \qquad ( 3 )$$

$$where :$$

$$\begin{matrix}{K}_{t\_hot} is the value of the torque constant at rated temperature , \\ {K}_{t\_cold} is the value of the torque constant at ambient temperature , \\ {T}_{rated} is the rated temperature of the motor windings , \\ {T}_{ambient} is the ambient temperature of the motor windings , and \\ {T}_{winding} is the present temperature of the motor windings .\end{matrix}$$

According to one aspect of the invention, the coefficients of the function defining the non-linear relationship between current and torque are stored in memory 115 of the motor drive 20. Optionally, these coefficients may be stored in memory 17 in the motor 10 and retrieved as discussed in more detail below. The processor 112 receives the current feedback signals 154 and the position feedback signal 121. The processor 112 then executes the frame transform 145 to obtain the q axis current, I_{q}, being supplied from the motor drive 20. The processor 112 further executes instructions to determine the electromagnetic torque as a function of the q axis current, I_{q}, and the coefficients stored in memory 115. The processor 112 receives a temperature feedback signal 158 from a temperature sensor 156 in the motor 10. The temperature sensor 156 is mounted within the motor such that the temperature feedback signal 158 corresponds to the temperature present in the motor windings. The processor 112 determines the compensation term corresponding to the measured temperature and, in turn, determines a compensated value of the electromagnetic torque that corresponds to both a curve fit to the non-linear relationship between current and torque and a measured temperature within the motor 10.

Having determined a compensated value of the electromagnetic torque, the processor 112 is further configured to determine torque at other points along the drivetrain. A first step along the drivetrain from the electromagnetic torque is a torque present at the output shaft of the motor. The motor shaft torque, τ_{shaft}, varies from the electromagnetic torque, τₑₘ, due to motor inertia, Jᵣₒₜₒᵣ, and friction in the motor. According to one aspect of the invention, values of motor inertia and friction for the motor 10 may be provided in a motor data sheet from the manufacturer. Optionally, these values may be determined using a commissioning process, as will be described in more detail below. The torque at the motor shaft may be determined as shown below in equation 4.

$${τ}_{shaft} = {τ}_{em} - {J}_{rotor} {α}_{rotor} - {τ}_{friction} \qquad ( 4 )$$

$$where :$$

$$\begin{matrix}{τ}_{shaft} is the torque at the motor shaft , \\ {τ}_{em} is the electromagnetic torque , \\ {J}_{rotor} is the motor intertia , \\ {α}_{rotor} is the angular acceleration in the rotor , and \\ {τ}_{friction} is the torque resulting from motor friction .\end{matrix}$$

According to one aspect of the invention, values of motor inertia and motor friction are stored in memory 115 of the motor drive 20. The processor 112 may then read a commanded acceleration for the rotor or, alternately, determine acceleration of the rotor as a function of the position feedback signal 121. A first derivative of the position feedback yields velocity feedback, and a second derivative of the position feedback yields acceleration feedback. The processor 112 calculates the electromagnetic torque, as described above, and further determines the motor shaft torque as a function of the electromagnetic torque, rotor acceleration, motor inertia, and motor friction. Alternately, the motor 10 may be configured to store parameters related to operation of the motor. With reference to FIG. 5, the motor 10 may include non-transitory memory 17 operative to store motor parameters. The motor 10 may further include a processor 15 in communication with the memory 17 and a communication interface 13. The motor drive 20 similarly includes a communication interface 113 and can transmit a read request from the motor drive 20 to the motor 10 to obtain motor parameters stored on the motor 10. The motor 10 sends a responsive data packet to the motor drive 20 containing parameters stored in the memory 17 on the motor 10. The rotor inertia and motor friction of a motor 10 may be determined by a manufacturer and stored in the memory 17 during the manufacturing process.

In addition to motor shaft torque, the motor drive 20 may be configured to determine torque at other desired locations along the drivetrain. A common drivetrain element connected to the output shaft of a motor 10 is a gearbox 21. An input of the gearbox 21 is coupled to the output shaft of the motor, and an output shaft 25 of the gearbox 21 is coupled to further elements in the drivetrain. The shaft torque present at the output shaft 25 of the gearbox 21 varies from the motor shaft torque as a function of the properties of the gearbox. Properties of the gearbox 21 that impact the shaft torque present at the output shaft of the gearbox include, but are not limited to, the type of gearbox, the gear ratio, friction, temperature, and gear efficiency. According to one aspect of the invention, a portion of these properties may be provided on a gearbox data sheet supplied by the manufacturer of the gearbox 21. Optionally, these values may be determined using a commissioning process, as will be described in more detail below.

According to one aspect of the invention, the motor drive 20 stores operating parameters of the gearbox 21 in memory 115. Some parameters, such as gear ratio, which are constant throughout an operating range of the gearbox 21 may be stored as a single parameter. Other parameters, such as efficiency, which may vary as a function of an operating temperature, operating speed, or input torque may be stored in one or more look-up tables in the memory 115 of the motor drive 20. The processor 112 in the motor drive receives feedback signals, such as temperature of the gearbox or speed of the motor 10 and has knowledge of previously calculated values such as the motor shaft torque. The processor 112 uses the feedback signals and previously calculated signals to determine the torque present at the output shaft 25 of the gearbox 21.

Optionally, the motor 10 and/or the gearbox 21 may be configured to store parameters related to operation of the gearbox 21. With reference again to FIG. 5, the motor 10 may include non-transitory memory 17 operative to store data such as the gearbox parameters. The motor 10 may further include a processor 15 in communication with the memory 17 and a communication interface 13. The gearbox 21 may similarly include non-transitory memory 28 operative to store data such as the gearbox parameters. The gearbox 21 may further include a processor 26 in communication with the memory 28 and a communication interface 24. Both the gearbox 21 and the motor 10 may communicate with a communication interface 113 present on the motor drive 20. Gearbox parameters may be determined by a manufacturer of the gearbox 21 and stored in the memory 28 during the manufacturing process. Alternately, a motor 10 and gearbox 21 to be installed together in an application may be connected and have commissioning steps performed to determine the gearbox parameters. The gearbox parameters may be stored in the memory 17 of the motor 10 such that they are available to the motor drive 20 to which the motor 10 will be connected. The motor drive 20 transmits a read request from the motor drive 20 to either the motor 10 or the gearbox 21 to obtain gearbox parameters. The motor 10 or gearbox 21 sends a responsive data packet to the motor drive 20 containing the requested parameters.

In addition to a motor 10 and gearbox 21, the drivetrain may include still other elements. According to the illustrated embodiment of FIG. 4, the drivetrain includes a coupler 30 between the output shaft 25 of the gearbox 21 and a further drive shaft 32. The additional drive shaft 32 is coupled to a load 35. The load 35 may include additional stages with further gearboxes, linkages, tools, wheels, end effector, or other actuator driven by the motor. At each stage along the drivetrain between the motor 10 and the final point at which work is performed on the load 35, the torque will vary due to gear ratios, mechanical inefficiencies, temperature, and the like. It is unlikely that data sheets will be available describing performance of each element in the drivetrain. Therefore, the motor drive 20 is further configured to perform one or more commissioning processes to determine a transfer function between the electromagnetic torque and/or the motor shaft torque and a subsequent location along the drivetrain.

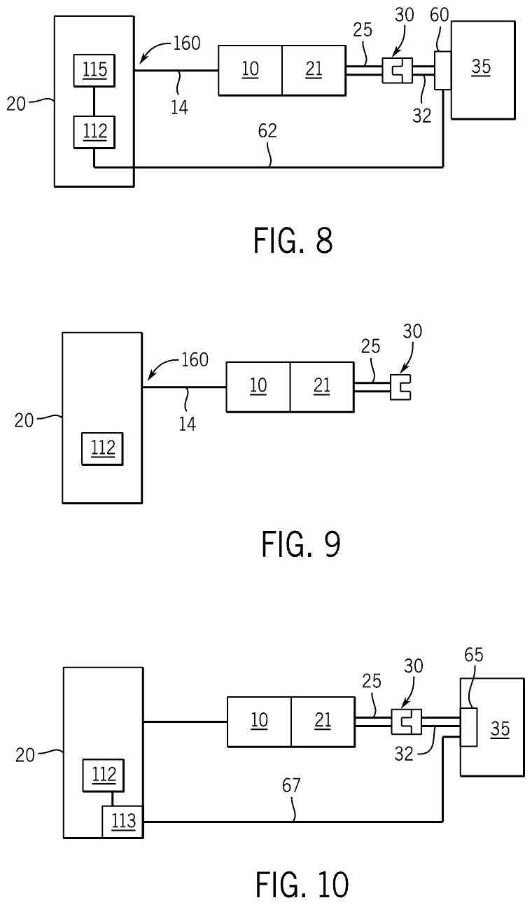

A first commissioning process utilizes a torque transducer 60, see FIG. 8, mounted along the drivetrain. The torque transducer 60 is installed on a temporary basis at a desired location along the drivetrain. According to the illustrated example, a torque transducer 60 is installed at the load 35, and a feedback signal 62, corresponding to the measured torque is provided to the processor 112 in the motor drive 20. The motor drive 20 is commanded to operate at a variety of operating conditions and the load 35 may be adjusted as available. In some applications, a temporary load may be coupled to the torque transducer 60 to provide the desired operating conditions. The motor drive 20 is commanded to run, for example, at twenty-five percent (25%) of rated speed, at fifty percent (50%) of rated speed, at seventy-five percent (75%) of rated speed, and at one hundred percent (100%) of rated speed with loads varying at ten percent (10%) increments. The operation may be repeated both from cold, or ambient, operating temperatures of the drivetrain and at rated, or hot, operating temperatures of the drivetrain. At each operating point, one or more values of the torque feedback signal 62 supplied by the torque transducer is stored.

According to one aspect of the invention, the motor drive 20 computes a transfer function of the measured torque with respect to the electromagnetic torque or the motor shaft torque. Optionally, the electromagnetic torque and/or the motor shaft torque along with the measured torque values are provided to an external processing device, and the external processing device determines the transfer function of the measured torque with respect to the electromagnetic torque or the motor shaft torque. The transfer function, or coefficients defining the transfer function, are stored in memory 115 of the motor drive 20. After the commissioning runs are complete, the torque transducer 60 is removed and the controlled system is prepared for normal operation. During operation of the controlled system, the processor 112 determines the electromagnetic torque, as described above, and reads the coefficients for the transfer function from memory 115. The processor 112 then determines the torque at the location along the drivetrain at which the transducer 60 was initially connected as a function of the electromagnetic torque and of the coefficients generated from the torque measured at the location during the commissioning runs.

A second commissioning process determines torque at a desired location of interest along the drivetrain without the use of a torque transducer for training. Rather, the drivetrain may be disconnected at a desired point of interest and multiple commissioning runs are performed. With reference to FIG. 9, the exemplary drivetrain is disconnected at the coupler 30. A first portion of the drivetrain, up to the coupler 30, remains connected, and a second portion of the drivetrain, beyond the coupler, is disconnected from the motor 10. The motor drive 20 first commands the motor 10 to operate at constant speed. The motor drive 20 commands the motor 10 to operate at a positive speed and at a negative speed. Preferably, the motor drive 20 commands the motor 10 to operate at two different positive speeds and at two different negative speeds. For each constant speed at which the motor drive 20 operates, the motor drive 20 measures the current output from the motor drive 20 and determines the shaft torque of the motor 10, as discussed above, with the portion of the drivetrain connected. A linear curve fit between the values of the shaft torque as determined during operation at the positive and negative speeds provides values of friction within the drivetrain. A slope of the curve fit line corresponds to the dynamic friction in the drivetrain and an offset of the curve fit line corresponds to the static friction in the drivetrain. After operating at constant speeds, the motor drive 20 commands the motor 10 to operate at a constant acceleration. As the motor drive 20 is commanding the motor 10 to operate at constant acceleration, the motor drive 20 again measures the current output from the motor drive 20 and determines the shaft torque with the portion of the drivetrain connected. From this shaft torque, an apparent inertia for the portion of the drivetrain that is connected is determined. The previously determined static and dynamic friction are subtracted from shaft torque to determine an acceleration torque. The acceleration torque is divided by the constant acceleration used to control the motor 10 to determine the apparent inertia.

Having determined static and dynamic frictions as well as apparent inertia for a portion of the drivetrain connected to the motor, the motor drive 20 may determine torque at the desired location along the drivetrain during operation of the motor 10 with the entire drivetrain connected. The torque at the point of interest is determined by first determining the motor shaft torque, as discussed above. The processor 112 reads the values of static friction, dynamic friction, and inertia as determined for the point of interest from memory 115. The processor 112 also reads a transmission ratio which defines an expected ratio of torque between the point of interest and the motor 10. The processor then determines torque at the point of interest as shown in equation 5 below.

$${τ}_{POI} = \frac{( {t}_{shaft} - {ω}_{motor} \cdot {K}_{d\_apparent} - sign ( {ω}_{motor} ) \cdot {K}_{s\_apparent} - {α}_{motor} \cdot {J}_{apparent} )}{{R}_{transmission}} \qquad ( 5 )$$

$$where :$$

$$\begin{matrix}{τ}_{POI} is the torque at the point of interest , \\ {τ}_{shaft} is the torque at the motor shaft , \\ {{ω}_{motor} is the angular velocity of the motor}_{\{ 2371139.0 DOCX / \}} , \\ {K}_{d\_apparent} is the apparent dynamic friction , \\ {K}_{s\_apparent} is the apparent static friction , \\ {α}_{motor} is the angular acceleration of the motor , \\ {J}_{apparent} is the apparent inertia , and \\ {R}_{transmission} is the transmission ratio between the point of interest and the motor .\end{matrix}$$

A third commissioning process utilizes a position encoder 65, see FIG. 10, mounted along the drivetrain. The position encoder 65 is installed on a temporary basis at a desired location along the drivetrain. According to the illustrated example, a position encoder 65 is installed at a point on the load 35, and a feedback signal 67, corresponding to the measured angular position of the drivetrain at the location of interest, is provided to the processor 112 in the motor drive 20 via the communication interface 113. A known load 35 is provided to the motor 10. The motor drive 20 is then commanded to output random noise or to provide a swept sinusoidal torque command to the motor 10 as a commissioning run. The motor drive 20 determines the motor shaft torque, as described above, and measures the position feedback signal 67 from the position encoder 65 mounted on the drivetrain. The measured position may be converted to a measured velocity by finding the first derivative of the position and to a measured acceleration by finding the second derivative of the position. With a known load, the torque at the point of interest may be determined as shown below in equation 6.

$${τ}_{POI} = {α}_{POI} \cdot {J}_{load} \qquad ( 6 )$$

$$where :$$

$$\begin{matrix}{τ}_{POI} is the torque at the point interest , \\ {α}_{POI} is the angular acceleration as measured at the point of interest , and \\ {J}_{load} is the inertia of the known load .\end{matrix}$$

According to one aspect of the invention, the motor drive 20 computes a fast Fourier transform (FFT) of the shaft torque and of the torque at the point of interest with respect to the random noise or swept sinusoidal torque command. The frequency response of the drivetrain is then determined by dividing the FFT of the shaft torque by the FFT of the torque at the point of interest. Optionally, the shaft torque, torque at the point of interest, and the reference signal used for the commissioning run are provided to an external processing device. The external processing device determines the FFT of the shaft torque, the FFT of the torque at the point of interest, and the frequency response of the drivetrain. A curve-fitting function may be executed on the frequency response of the drive train to obtain a transfer function or coefficients of a transfer function corresponding to the frequency response. The transfer function, or coefficients defining the transfer function, are stored in memory 115 of the motor drive 20. After the commissioning run is complete, the position encoder 65 may be removed and the controlled system is prepared for normal operation. During operation of the controlled system, the processor 112 determines the motor shaft torque, as described above, and reads the coefficients for the transfer function from memory 115. The processor 112 then determines the torque at the point of interest along the drivetrain at which the encoder 65 was initially connected as a function of the motor shaft torque and of the coefficients generated from the commissioning run.

The present invention permits torque to be calculated at various locations along a drivetrain without requiring the presence of a torque transducer. Initial commissioning steps are used to characterize a load, and a resultant transfer function or operating parameters determined during the commissioning steps are stored in the motor drive for use during normal operation. Optionally the resultant transfer function or measured operating parameters may be stored in the motor 10 or in the gearbox 21. The motor drive 20 is able to determine torque outside of the motor 10 without the use of a physical sensor. By determining torque values at various locations along the drivetrain, the motor drive 20 may provide system protection and condition monitoring without the expense of a torque transducer.

It should be understood that the invention is not limited in its application to the details of construction and arrangements of the components set forth herein. The invention is capable of other embodiments and of being practiced or carried out in various ways. Variations and modifications of the foregoing are within the scope of the present invention. It also being understood that the invention disclosed and defined herein extends to all alternative combinations of two or more of the individual features mentioned or evident from the text and/or drawings. All of these different combinations constitute various alternative aspects of the present invention. The embodiments described herein explain the best modes known for practicing the invention and will enable others skilled in the art to utilize the invention.

In the preceding specification, various embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

We claim:

1. A method for determining torque in a drivetrain in real-time, comprising the steps of
receiving a reference signal at a motor drive, wherein the reference signal corresponds to a desired operation of a motor connected to the motor drive;
generating an output current from the motor drive to control operation of the motor;
measuring the output current from the motor drive as it is supplied to the motor;
obtaining at least two coefficients defining a torque constant of the motor;
determining an electromagnetic torque for the motor using the motor drive, wherein the electromagnetic torque is determined as a function of the output current and of the at least two coefficients defining the torque constant;
measuring a temperature of a winding in the motor;
determining a compensated value of the electromagnetic torque generated by the motor in real-time as a function of the electromagnetic torque and of the temperature of the winding;
obtaining a rotor inertia and a motor friction of the motor; and
determining a shaft torque for an output shaft of the motor in the motor drive as a function of the electromagnetic torque, the rotor inertia, and the motor friction.

2. The method of claim 1, wherein the step of obtaining the rotor inertia and the motor friction of the motor further comprises the steps of:
transmitting a read request from the motor drive to the motor to read the rotor inertia and the motor friction from a non-volatile memory in the motor; and
receiving the rotor inertia and the motor friction at the motor drive in a responsive data packet from the motor.

3. The method of claim 1, further comprising the steps of:
obtaining at least one gearbox parameter corresponding to an operating characteristic of a gearbox operatively coupled to the motor; and
determining a second shaft torque for an output shaft of the gearbox in the motor drive as a function of the shaft torque for the output shaft of the motor and of the at least one gearbox parameter.

4. The method of claim 3, wherein the step of obtaining the at least one gearbox parameter further comprises the steps of:
transmitting a read request from the motor drive to the motor to read the at least one gearbox parameter from a non-volatile memory in the motor; and
receiving the at least one gearbox parameter at the motor drive in a responsive data packet from the motor.

5. The method of claim 3, wherein the step of obtaining the at least one gearbox parameter further comprises the steps of:
transmitting a read request from the motor drive to the gearbox to read the at least one gearbox parameter from a non-volatile memory in the gearbox; and
receiving the at least one gearbox parameter at the motor drive in a responsive data packet from the gearbox.

6. The method of claim 1 further comprising the steps of:
receiving an initial commissioning reference signal at the motor drive, wherein the commissioning reference signal corresponds to a desired commissioning run of the motor and at least a portion of the drivetrain;
determining a torque at a location along the drivetrain other than an output shaft of the motor during the commissioning run; and
determining a torque value at the location along the drivetrain during a subsequent operation of the drivetrain as a function of the compensated electromagnetic torque and of the torque determined during the commissioning run.

7. A method for determining torque in a drivetrain in real-time, comprising the steps of:
receiving an initial commissioning reference signal at a motor drive, wherein the commissioning reference signal corresponds to a desired commissioning run of a motor connected to the motor drive and of a portion of the drivetrain;
determining a torque at a location along the drivetrain other than an output shaft of the motor during the commissioning run;
receiving a subsequent reference signal at the motor drive, wherein the subsequent reference signal corresponds to a desired operation of the motor;
generating an output current from the motor drive to control operation of the motor responsive to the subsequent reference signal;
measuring the output current from the motor drive as it is supplied to the motor while executing the subsequent reference signal;
determining an electromagnetic torque for the motor using the motor drive, wherein the electromagnetic torque is determined as a function of the output current measured while executing the subsequent reference signal; and
determining the torque at the location along the drivetrain while executing the subsequent reference signal as a function of the electromagnetic torque and of the torque determined at the location during the commissioning run.

8. The method of claim 7, wherein the step of determining the torque at the location along the drivetrain other than the output shaft of the motor during the commissioning run further comprises the steps of:
operatively connecting a torque sensor to the location along the drivetrain; and
measuring the torque at the location from a feedback signal generated by the torque sensor during the commissioning run.

9. The method of claim 7, wherein the step of determining the torque at the location along the drivetrain other than the output shaft of the motor during the commissioning run further comprises the steps of:
disconnecting a remainder of the drivetrain beyond the location;
running the motor at a plurality of constant motor speeds;
measuring the output current while running the motor at the plurality of constant motor speeds;
determining a shaft torque as a function of the output current for each of the plurality of constant motor speeds;
determining friction along the drivetrain as a function of the shaft torque determined for each of the plurality of constant speeds;
running the motor at a constant acceleration;
measuring the output current while running the motor at the constant acceleration;
determining a shaft torque as a function of the output current for constant acceleration; and
determining system inertia as a function of the shaft torque determined for constant acceleration, wherein the torque is determined as a function of the friction and the system inertia.

10. The method of claim 7, wherein the step of determining the torque at the location along the drivetrain other than the output shaft of the motor during the commissioning run further comprises the steps of:
operatively connecting a position sensor to the location along the drivetrain;
operatively connecting a known load to the drivetrain;
measuring a position feedback signal from the position sensor during the commissioning run;
determining an angular acceleration at the location as a function of the position feedback signal; and
determining the torque at the location as a function of the angular acceleration and an inertia of the known load.

11. The method of claim 7 further comprising the steps of:
determining a transfer function, coefficients of a transfer function, or an operating parameter as a function of the torque determined during the commissioning run; and
storing the transfer function, coefficients of a transfer function, or an operating parameter in memory of the motor drive, the motor, or a gearbox operatively coupled to the motor.

12. A system for determining torque at a point of interest along a drivetrain in real-time without a sensor mounted at the point of interest, the system comprising:
a motor operatively connected to drive the drivetrain; and
a motor drive operatively connected to control operation of the motor, wherein the motor drive further comprises:
a current sensor operative to generate a current feedback signal corresponding to a current supplied from the motor drive to the motor; and
a processor operative to:
execute at least one commissioning run of the motor, wherein the at least one commissioning run controls operation of the motor according to a known motion profile,
store either an operating parameter or at least one transfer function coefficient in memory, wherein the operating parameter or the at least one transfer function coefficient corresponds to a torque produced at the point of interest during the at least one commissioning run,
execute at least one additional run after the commissioning run,
determine an electromagnetic torque in the motor as a function of the current supplied from the motor drive to the motor during the at least one additional run, and
determine a torque generated at the point of interest in real-time during the at least one additional run as a function of the electromagnetic torque and the operating parameter or the at least one transfer function coefficient.

13. The system of claim 12, further comprising:
a temperature sensor mounted in the motor, wherein:
the temperature sensor generates a temperature feedback signal corresponding to a temperature of a winding in the motor,
the temperature feedback signal is transmitted to the processor in the motor drive,
the processor is further operative to:
read at least one coefficient from memory, wherein the at least one coefficient defines a non-linear relationship between torque and current in the motor,
determine the electromagnetic torque as a function of the current supplied from the motor drive to the motor and as a function of the at least one coefficient.

14. The system of claim 13, further comprising:
a first communication interface in the motor drive,
a second communication interface in the motor, wherein the first and the second communication interfaces are operatively connected to each other,
a memory in the motor, wherein the memory in the motor stores the at least one coefficient, and
a processor in the motor, wherein:
the processor in the motor drive is operative to generate a read request data packet requesting the at least one coefficient from the motor, and
the processor in the motor is operative to generate a responsive data packet to the motor drive including the at least one coefficient.

15. The method of claim 12, wherein:
the point of interest is a motor shaft of the motor,
the processor in the motor drive is further operative to:
read a rotor inertia and a motor friction from memory, and
determine a motor shaft torque as a function of the electromagnetic torque, the rotor inertia, and the motor friction.

16. The system of claim 15, further comprising:
a first communication interface in the motor drive,
a second communication interface in the motor, wherein the first and the second communication interfaces are operatively connected to each other,
a memory in the motor, wherein the memory in the motor stores the rotor inertia and the motor friction, and
a processor in the motor, wherein:
the processor in the motor drive is operative to generate a read request data packet requesting the rotor inertia and the motor friction from the motor, and
the processor in the motor is operative to generate a responsive data packet to the motor drive including the rotor inertia and the motor friction.

17. The system of claim 12, further comprising a gearbox operatively coupled to an output shaft of the motor, wherein
the point of interest is an output shaft of the gearbox, and
the processor is further operative to:
read at least one gearbox parameter from memory, and
determine the torque generated at the output shaft of the gearbox as a function of the electromagnetic torque and of the at least one gearbox parameter.

18. The system of claim 17, further comprising:
a first communication interface in the motor drive,
a second communication interface in the motor, wherein the first and the second communication interfaces are operatively connected to each other,
a memory in the motor, wherein the memory in the motor stores at least one gearbox parameter, and
a processor in the motor, wherein:
the processor in the motor drive is operative to generate a read request data packet requesting the at least one gearbox parameter from the motor, and
the processor in the motor is operative to generate a responsive data packet to the motor drive including the at least one gearbox parameter.

19. The system of claim 17, further comprising:
a first communication interface in the motor drive,
a second communication interface in the gearbox, wherein the first and the second communication interfaces are operatively connected to each other,
a memory in the gearbox, wherein the memory in the gearbox stores at least one gearbox parameter, and
a processor in the gearbox, wherein:
the processor in the motor drive is operative to generate a read request data packet requesting the at least one gearbox parameter from the gearbox, and
the processor in the gearbox is operative to generate a responsive data packet to the motor drive including the at least one gearbox parameter.

20. The system of claim 12, further comprising an additional sensor operatively connected to the drivetrain during the at least one commissioning run, wherein:
the additional sensor generates a feedback signal corresponding either to a measured torque or to an angular position of the drivetrain at the point of interest during the at least one commissioning run; and
the at least one transfer function coefficient is determined as a function of the feedback signal.
